(19) United States
(12) Patent Application Publication
(10) Pub. No.: US 2014/0074613 A1
(43) Pub. Date: Mar. 13, 2014

(54) Methods, Systems, and Products for Queuing Advertisements

(71) Applicants: MOSTAFA TOFIGHBAKHSH, Cupertino, CA (US); SHYAM P. PAREKH, Orinda, CA (US)

(72) Inventors: MOSTAFA TOFIGHBAKHSH, Cupertino, CA (US); SHYAM P. PAREKH, Orinda, CA (US)

(73) Assignee: AT&T INTELLECTUAL PROPERTY I, L.P., Atlanta, GA (US)

(21) Appl. No.: 13/607,673

(22) Filed: Sep. 8, 2012

(51) Int. Cl. G06Q 30/02

(52) U.S. Cl. 705/14.64

(57) ABSTRACT

Methods, systems, and products allow advertisers to self-manage their advertisements. An advertiser submits an advertisement to a queue for delivery to end user devices. Before the advertisement is presented, a set of conditions may be defined that govern presentation. A current value of each condition may be provided in a user interface. The user interface may display a position of the advertisement in the queue, based on the current value of each condition. When each condition in the set of conditions is satisfied, the advertisement may then be removed from the queue and presented.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Advertisers target advertisements to potential customers. Each advertisement may be associated with a set of conditions that target delivery. When each condition is satisfied, the advertisement is sent to a potential customer.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating a graphical user interface, according to exemplary embodiments;

FIG. 2 is an illustration of a user interface, according to exemplary embodiments;

FIG. 3 is a more detailed schematic illustrating an operating environment, according to exemplary embodiments;

FIG. 4 is a schematic illustrating local targeting, according to exemplary embodiments;

FIG. 5 is a schematic illustrating network data, according to exemplary embodiments;

FIG. 6 is another illustration of the user interface, according to exemplary embodiments;

FIGS. 7-8 are schematics illustrating calibration of local targeting, according to exemplary embodiments;

FIGS. 9-12 are schematics illustrating a target update, according to exemplary embodiments;

FIG. 13 is a schematic illustrating recalibration, according to exemplary embodiments;

FIG. 14 is a schematic illustrating a web server, according to exemplary embodiments;

FIG. 15-18 are flowcharts illustrating a method or algorithm for targeting the advertisement, according to exemplary embodiments; and

FIGS. 19-20 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

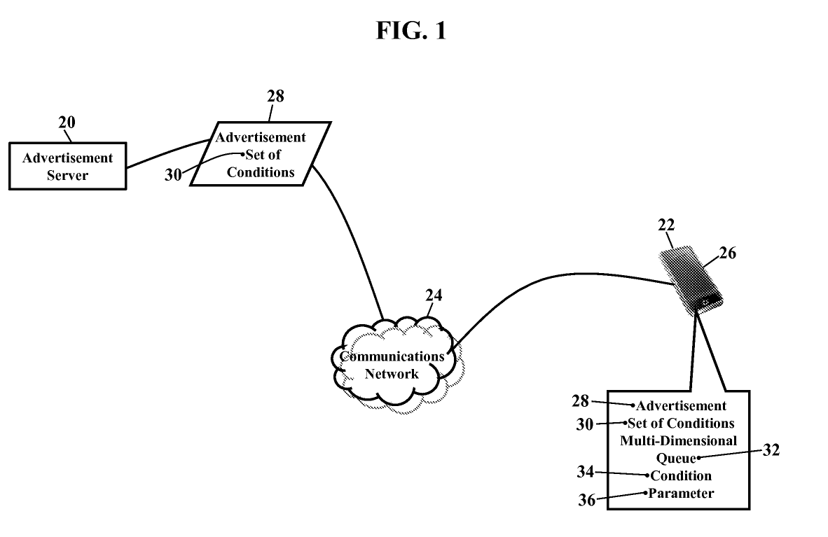

FIG. 1 is a simplified schematic illustrating an environment in which exemplary embodiments may be implemented. An advertisement server 20 communicates with an end user device 22 via a communications network 24. The end user device 22 is illustrated as a smart phone 26, but the end user device 22 may be any computer, tablet, or any other processor-controlled device. The advertisement server 20 sends an advertisement 28 to an address associated with the end user device 22. The advertisement server 20 also sends a set 30 of conditions for local presentation of the advertisement 28. The set 30 of conditions may be separately sent from the advertisement 28, or the set 30 of conditions may be incorporated into and/or sent with the advertisement 28. Regardless, the end user device 22 stores the advertisement 28 and the set 30 of conditions in local memory. The end user device 22 also queues the advertisement 28 in a multi-dimensional queue 32. Each dimension in the multi-dimensional queue 32 corresponds with one condition 34 in the set 30 of conditions. Each condition 34 may also involve one or more parameters 36. The end user device 22 locally compares the various parameters 36 to the conditions 34 in the set 30 of conditions. When the end user device 22 determines that all the individual conditions 34 are satisfied, then the end user device 22 releases the advertisement 28 from the multi-dimensional queue 32. That is, the end user device 22 authorizes presentation of the advertisement 28. The end user device 22 thus visually displays, and/or audibly presents, the advertisement 28 to a user of the end user device 22.

Exemplary embodiments thus describe localized targeting of the advertisement 28. Conventional schemes for targeted advertising use a remote server. The remote server gathers the parameters 36 and compares the set 30 of conditions. When the set 30 of conditions is satisfied, the advertisement 28 is conventionally sent from the remote server for unicast or broadcast delivery to the end user device 22.

Exemplary embodiments, though, localize targeting. Here the end user device 22 gathers the parameters 36 and compares the set 30 of conditions. When the end user device 22 determines that the set 30 of conditions is satisfied, then the advertisement 28 is visually displayed to the user. Because the end user device 22 performs the comparisons, targeting of the advertisement 28 is completely and locally performed. Because the advertisement 28 is downloaded to the end user device 22, network access is not required for targeted advertising. The advertisement 28 is, instead, locally stored and retrieved. Moreover, the end user device 22 itself retrieves and compares the various parameters 36 to the set 30 of conditions associated with the advertisement 28 in the multi-dimensional queue 32. The set 30 of conditions may be logically defined based solely on local parameters 36, thus again not requiring network access for targeted delivery. If the end user device 22 can locally obtain the parameters 36, the set 30 of conditions may be evaluated without network access. Even if the parameters 36 require queries to a remote device, intermittent or low-bandwidth network access is only required. Regardless, when the end user device 22 determines that the set 30 of conditions is satisfied, the end user device 22 leaks the advertisement 28 from the multi-dimensional queue 32. The end user device 22 thus visually and/or audibly presents the targeted advertisement 28.

The multi-dimensional queue 32 may queue multiple advertisements. Multiple advertisements may be downloaded to the end user device 22. Each advertisement 28 may be associated with its own set 30 of conditions. A group of the advertisements may additionally or alternatively be associated with a common set 30 of conditions. Regardless, the various parameters are retrieved and compared to the set 30 of conditions. When any advertisement 28 satisfies its associated set 30 of conditions, the advertisement 28 is leaked from the multi-dimensional queue 32 for visual and/or audible presentation.

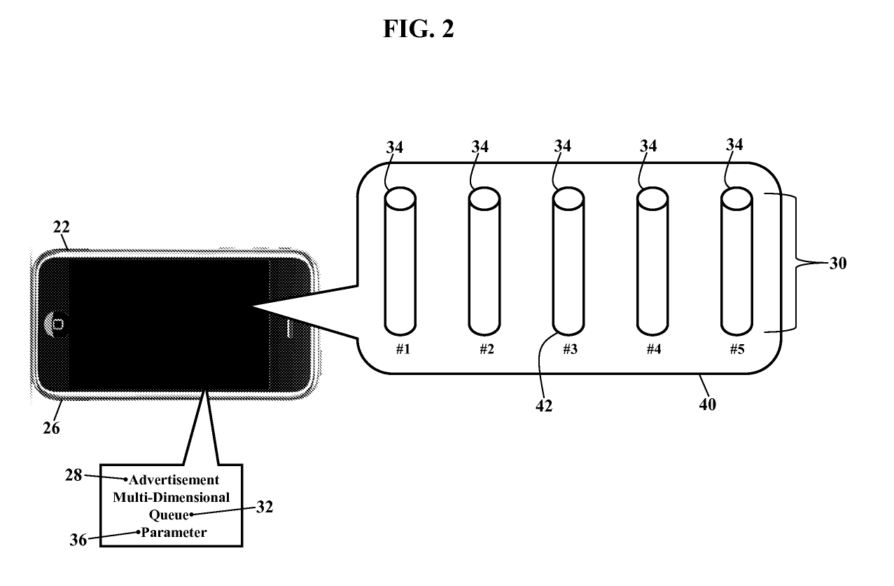

FIG. 2 is an illustration of a user interface 40, according to exemplary embodiments. The user interface 40 may be presented by the end user device 22. The user interface 40, for example, may be displayed on a display of the smart phone 26. FIG. 2 illustrates an enlarged view of the user interface 40, for clarity. The user interface 40 illustrates the set 30 of conditions associated with the advertisement 28. As those of ordinary skill in the art understand, the set 30 of conditions govern presentation of the advertisement 28. Each condition 34, in the set 30 of conditions, defines one or more rules or logical statements that must be met before the advertisement 28 is removed from the multi-dimensional queue 32. The set 30 of conditions, for example, may include some demographic parameter (e.g., age, income, sex), location, and/or device parameter (such as available memory, model or capability), calendar date and time, or any other logical expression. FIG. 2 illustrates five (5) separate, individual conditions 34 in the set 30 of conditions. In actual practice, though, the advertisement 28 may have a fewer number, or a greater number, of individual conditions 34. Regardless, when the set 30 of conditions is satisfied, the advertisement 28 is visually and/or audibly presented.

The user interface 40 allows an end user to observe the set 30 of conditions. Whatever the set 30 of conditions, the user interface 40 graphically illustrates the set 30 of conditions. Each individual condition 34, in the set 30 of conditions, may be separately represented to monitor the advertisement's progress toward presentation. Because there may be multiple, individual conditions, the advertisement 28 awaits delivery in the multi-dimensional queue 32. While each individual condition 34 may be represented with any graphical representation, FIG. 1 illustrates each individual condition 34 as a chimney 42. Each graphical representation thus illustrates one dimension in the multi-dimensional queue 32. When a particular condition 34 is satisfied, the associated advertisement 28 may graphically move into the corresponding chimney 42. As more individual conditions 34 are also satisfied, the advertisement 28 is graphically moved into more associated chimneys 42. When the entire set 30 of conditions is satisfied, the advertisement 28 will have graphically graduated through all the graphical representations. Because all the conditions 34 have been satisfied, the advertisement 28 is then authorized for presentation. The advertisement 28 may thus be retrieved and played/displayed by the end user device 22.

The multi-dimensional queue 32 may be established for any number of end user devices 22. That is, the advertisement 28 may be targeted to a single end user device 22 or to a group of multiple end user devices 22, according to the set 30 of conditions. Because the set 30 of conditions are locally evaluated in each end user device 22, the same set 30 of conditions may produce different presentation dates and times for the same advertisement 28. After the advertisement 28 is downloaded to each individual end user device 22, the advertisement 28 may automatically shift into, and out of, the various chimneys 42 until all the conditions 34, in the set 30 of conditions, are satisfied. When all the conditions 34 in the set 30 of conditions are met, the advertisement 28 is released from the N-dimensional queue 32. The advertisement 28 may thus be retrieved from the local memory of the end user device 22 and presented for display.

Exemplary embodiments thus benefit both advertisers and end users. Because the set 30 of conditions is locally evaluated by the end user device 22, targeting of the advertisement 28 is under the full control of retailers/advertisers. An advertiser merely establishes the set 30 of conditions for the advertisement 28. Once the advertisement 28, and the set 30 of conditions, are delivered to the end user device 22, targeting does not require network access. Targeting is also immune to network problems, outages, and congestion. Indeed, the advertisement 28 may still be presented even if the end user has late payment, or even non-payment, issues with a network provider or other third party. The user interface 40 thus presents a digital dashboard of the smart, multi-dimensional queue 32.

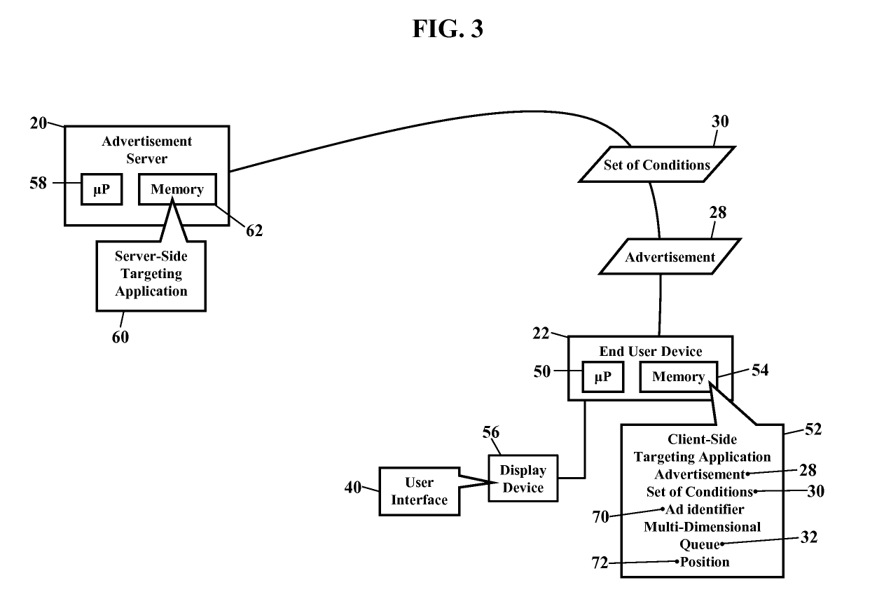

FIG. 3 is a more detailed schematic illustrating an operating environment, according to exemplary embodiments. The advertisement server 20 and the end user device 22 cooperate to transfer the advertisement 28 and the set 30 of conditions. FIG. 3 illustrates the set 30 of conditions being separately transferred, but the advertisement 28 and the set 30 of conditions may be integrated. The advertisement 28 and the set 30 of conditions route along the communications network (illustrated as reference numeral 24 in FIG. 1) to the end user device 22. The end user device 22 may have a processor 50 (e.g., “μP”), application specific integrated circuit (ASIC), or other component that executes a client-side targeting application 52 stored in a local memory 54. The client-side targeting application 52 may cause the processor 50 to produce the graphical user interface 40 on a display device 56, yet the graphical user interface 40 may also have audio and/or video features. The advertisement server 20 may also have a processor 58 (e.g., “μP”), application specific integrated circuit (ASIC), or other component that executes a server-side targeting application 60 stored in a memory 62. The client-side targeting application 52 and the server-side targeting application 60 may thus be instructions, code, and/or programs that cooperate to deliver the advertisement 28, and the set 30 of conditions, to the end user device 22. The advertisement 28 and the set 30 of conditions may then be stored in the memory 54 of the end user device 22.

Local queuing is performed. The client-side targeting application 52 retrieves an advertisement identifier 70 associated with the advertisement 28. The advertisement identifier 70 may be any alphanumeric combination that uniquely identifies the advertisement 28 from all other advertisements stored in the local memory 54 of the end user device 22. Whatever the advertisement identifier 70, the advertisement 28 (and/or the advertisement identifier 70) may be assigned a position 72 in the multi-dimensional queue 32.

Exemplary embodiments may be applied regardless of networking environment. The communications network 24 may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the IEEE 802 family of standards, GSM/CDMA/TDMA or any cellular standard, and/or the ISM band). The communications network 24 may even include powerline portions, in which signals are communicated via electrical wiring. The concepts described herein may be applied to any wireless/wireline communications network, regardless of physical componentry, physical configuration, or communications standard(s).

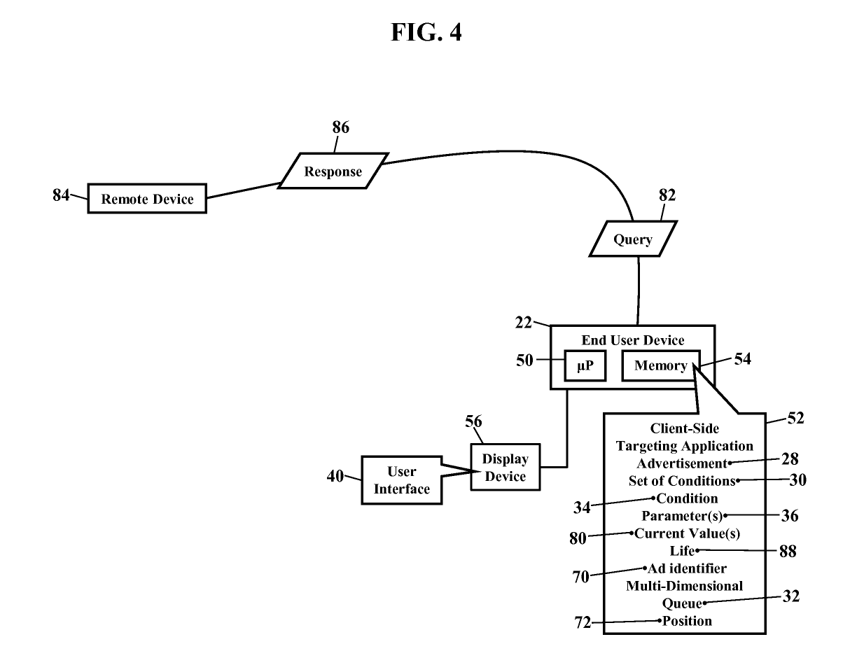

FIG. 4 is a schematic illustrating local targeting, according to exemplary embodiments. Here the client-side targeting application 52 retrieves the parameters 36 required for the set 30 of conditions. Each condition 34, in the set 30 of conditions, is associated with the one or more parameters 36. The parameters 36, for example, may specify location, demographics, date/time, or any other metric. Whatever the parameters 36, the client-side targeting application 52 retrieves a current value 80 of each required parameter 36.

Some parameters 36, for example, may be obtained from the local memory 54 of the end user device 22. If the end user device 22 has global positioning system (“GPS”) capabilities, then the client-side targeting application 52 may instruct the processor 50 to retrieve current GPS coordinates representing the current location of the end user device 22. Some parameters 36 may require a hardware or software capability of the end user device 22, such as display size, display resolution, available memory, or software presence (e.g., ADOBE® FLASH® player). Hardware and software capabilities may also be retrieved from the local memory 54. Whatever the parameters 36, the client-side targeting application 52 may retrieve the current value 80 of any parameter 36 from the local memory 54.

Other parameters 36, though, may be remotely obtained. Some parameters 36 may not be locally stored in the local memory 54, so the client-side targeting application 52 may query for the current value 80 of the parameter 36. As FIG. 4 illustrates, the client-side targeting application 52 may instruct the processor 50 to send a query 82 to a remote device 84. The query 82 routes through the communications network (illustrated as reference numeral 24 in FIG. 1) to a network address associated with the remote device 84. The query 82 may specify the parameter 36 being sought. The remote device 84 (such as a remote server) retrieves the current value 80 of the parameter 36 and sends a response 86. The response 86 routes through the communications network 24 to the network address associated with the end user device 22. The client-side targeting application 52 obtains the current value 80 of the desired parameter 36 from the response 86, and the current value 80 is stored in the local memory 54.

Some parameters 36 may even be stale. Even though the parameter 36 may be stored in the local memory 54 of the end user device 22, the parameter 36 may be too old for reliable use. The parameter 36, for example, may have a life 88 that defines a maximum age of the parameter 36. If a date and time of the parameter 36 is too old, when compared to a current date and time, then the client-side targeting application 52 may need to refresh the parameter 36. The client-side targeting application 52 may then send the query 82 to the remote device 84 to obtain the fresh, current value 80 of the parameter 36. When the end user device 22 receives the response 86, the latest current value 80 of the desired parameter 36 is stored in the local memory 54.

Local targeting may then commence. Once the current values 80 of all the required parameters 36 are retrieved, the client-side targeting application 52 begins evaluating each condition 34 in the set 30 of conditions. The logical expression of each condition 34 may be evaluated using the current values 80 of its associated parameters 36. As any condition 34 is satisfied, the position 72 of the advertisement 28 (or its associated advertisement identifier 70) may change in the multidimensional queue 32. The client-side targeting application 52 may also visually update the graphical user interface 40 to reflect the current position 72 of the advertisement 28 in the multidimensional queue 32. When the client-side targeting application 52 determines that all the individual conditions 34, in the set 30 of conditions, are satisfied, then the client-side targeting application 52 releases the advertisement 28 from the multi-dimensional queue 32. The client-side targeting application 52 may then instruct the processor 50 to visually display the advertisement 28 on the display device 56.

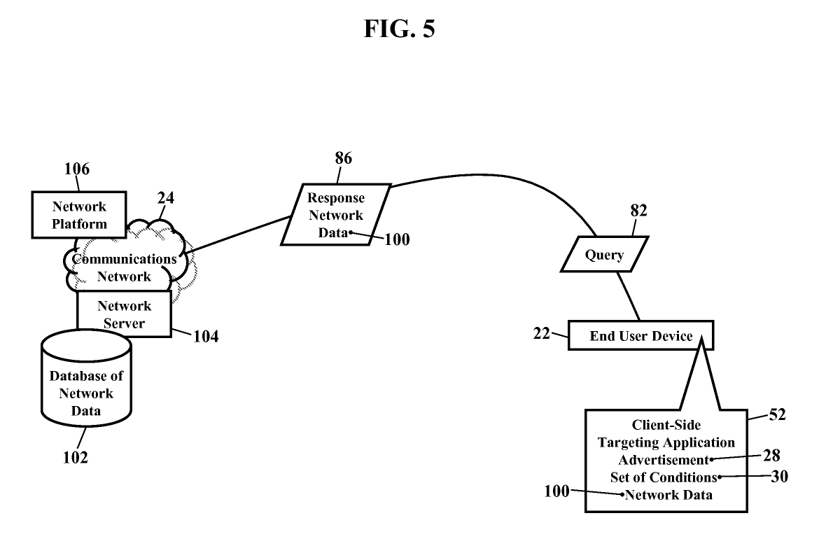

FIG. 5 is a schematic illustrating network data 100, according to exemplary embodiments. The set 30 of conditions may require information or data that is only available from an operator of the communications network 24. The set 30 of conditions, for example, may require real time or statistical network performance data (such as packet timing, device loading, or routing data) that is only available from the operator of the communications network 24. The set 30 of conditions, as another example, may require real time or statistical domain name system (“DNS”) performance data (such as queries per hour to a domain name server) that is only available from the operator of the communications network 24. The client-side targeting application 52 may thus query a database 102 of network data for the network data 100. The database 102 of network data is illustrated as being locally stored in a network server 104. The database 102 of network data interfaces with one or more network platforms 106 that monitor conditions in the communications network 24. The database 102 of network data thus stores any network data 100 that is collected from the network platforms 106. Whenever the network data 100 is required for targeted advertising, queries may be sent to the database 102 of network data. FIG. 5 thus illustrates the end user device 22 sending the query 82 to the network address associated with the network server 104. The network server 104 queries the database 102 of network data and retrieves the requested network data 100. The network server 104 sends the network data 100 in the response 86, and the response 86 routes to the network address associated with the end user device 22. Now that the network data 100 is known, the client-side targeting application 52 evaluates the set 30 of conditions using the network data 100.

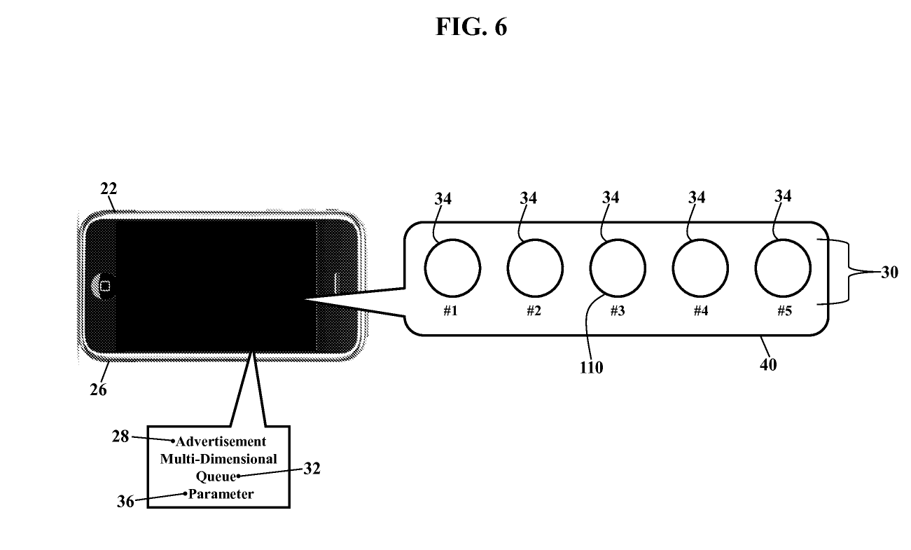

FIG. 6 is another illustration of the user interface 40, according to exemplary embodiments. The user interface 40 is again enlarged for clarity. FIG. 6 illustrates that any icon or representation may be used to graphically illustrate the condition(s) 34 in the set 30 of conditions. As earlier paragraphs explained, the user interface 40 provides a simple, graphical illustration of the set 30 of conditions. When a particular condition 34 is satisfied, that satisfaction may be graphically illustrated in the user interface 40. Earlier descriptions of the user interface 40 used the chimney (illustrated as reference numeral 42 in FIG. 2) to illustrate each condition 34 in the set 30 of conditions. FIG. 6, though, illustrates an even simpler representation using a series of graphical stop lights 110. Each stop light 110 is associated with a particular condition 34 in the set 30 of conditions. When a condition 34 is satisfied, its associated iconic stop light 110 may be colored “green” to indicate satisfaction towards presentation. If the condition 34 is not satisfied, the stop light 110 may be colored “red” to indicate the condition 34 is still awaiting satisfaction. A “yellow” coloring may indicate the condition 34 is nearly, but not yet, satisfied. When all the stop lights 110 are colored “green,” then the corresponding advertisement 28 is authorized for presentation. Color coding, of course, may be implemented with any representation of the set 30 of conditions. Different colors may represent different stages of satisfaction of a particular condition 34 in the set 30 of conditions.

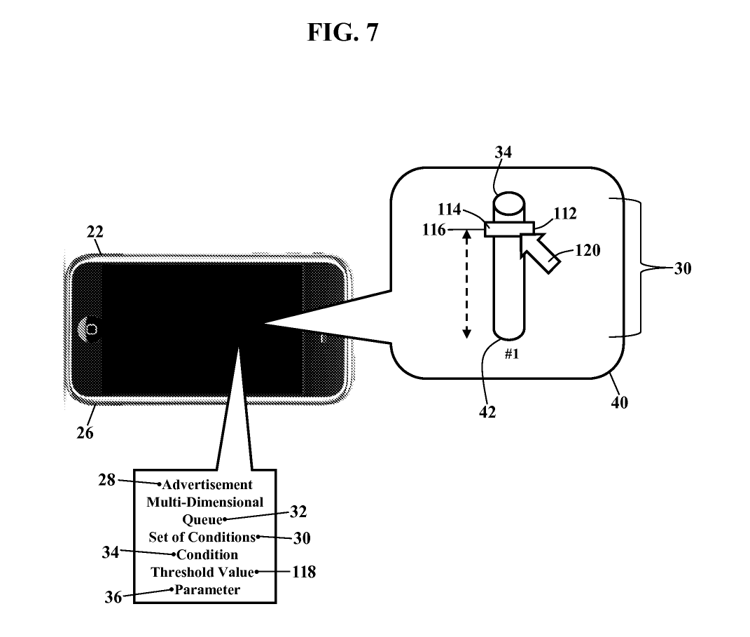

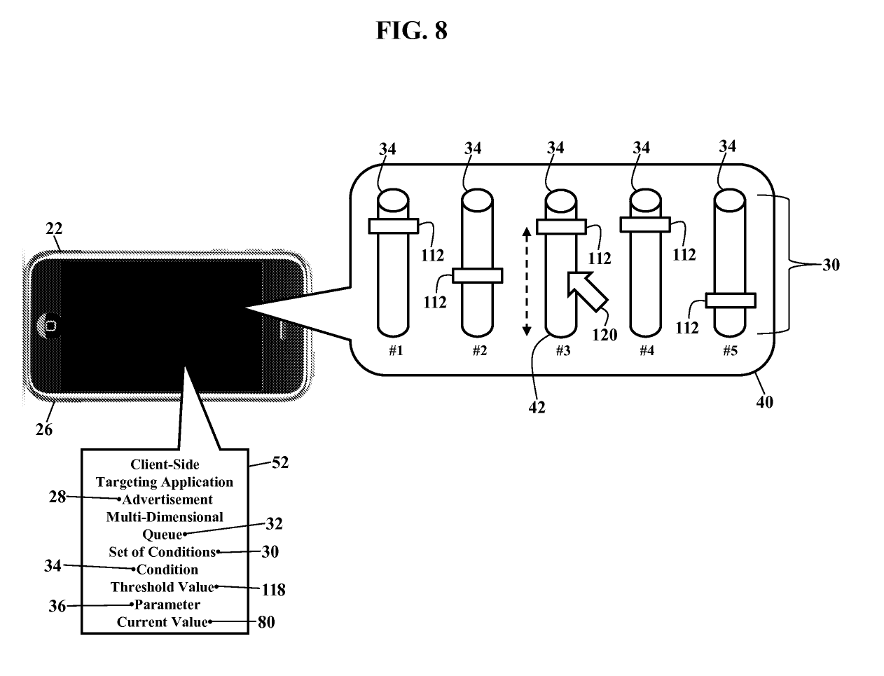

FIGS. 7-8 are schematics illustrating calibration of local targeting, according to exemplary embodiments. Here the user interface 40 allows a user to quickly, and simply, change any condition 34 in the set 30 of conditions. FIG. 7, for simplicity, only illustrates a single condition 34 represented as the chimney 42. Here, though, the chimney 42 may also have a graphical control 112. The graphical control 112 is illustrated as slider 114 that may be moved, or slid, along the chimney 42. A vertical location 116 of the graphical control 112 is associated with a threshold value 118 of the corresponding condition 34. The user may thus move the graphical control 112 to change the threshold value 118 of the corresponding condition 34. The user, for example, places a cursor 120 on or near the slider 114 and slides the graphical control 112 to a new vertical location 116. The vertical location 116 of the slider 114 is scaled to the threshold value 118. If the graphical control 112 is upwardly slid, for example, the corresponding threshold value 118 may be increased towards a maximum value. If the graphical control 112 is downwardly slid, the corresponding threshold value 118 may be decreased from the maximum value. The simple graphical control 112 may thus be used to quickly change the threshold value 118 associated with the condition 34. By changing the vertical location 116 of the graphical control 112, the user may determine how quickly the condition 34 is satisfied.

FIG. 8 also illustrates calibration. Here, though, multiple conditions 34 are illustrated. Each individual condition 34 has its own associated graphical control 112 for adjusting its associated threshold value 118. The user may thus place the cursor 120 on any graphical control 112 to change the threshold value 118 of the associated condition 34. The user may thus quickly increase, or decrease, a GPS location requirement (e.g., a radius or range of coordinates). The user may adjust a requirement for web page impressions, for bytes received or sent, for pixel resolution, or for any other numeric value.

The threshold value 118 determines satisfaction of the associated condition 34. As the client-side targeting application 52 evaluates the set 30 of conditions, the client-side targeting application 52 may compare the current value 80 of the parameter 36 to the corresponding threshold value 118. When the current value 80 of the parameter 36 satisfies the corresponding threshold value 118, the corresponding condition 34 may be satisfied. The advertisement 28 may thus move closer to presentation in the multi-dimensional queue 32. By moving any graphical control 112, the user may simply and quickly change the threshold value 118, thus promoting or demoting the advertisement 28 in the multidimensional queue 32. In other words, by moving the graphical control 112, the user may simply and quickly advance, or delay, presentation of the advertisement 28.

Exemplary embodiments may thus visually display the set 30 of conditions. Because the client-side targeting application 52 obtains the current values 80 of the parameters 36, exemplary embodiments provide a real time graphical view of the set 30 of conditions prior to presentation of the advertisement 28. That is, the user may view current progress towards satisfaction of each condition 34 in the set 30 of conditions. Once each condition 34 is satisfied, the client-side targeting application 52 may release the advertisement 28 from the multi-dimensional queue 32. The client-side targeting application 52 may then instruct the processor (illustrated as reference numeral 50 in FIG. 3) to play the advertisement 28.

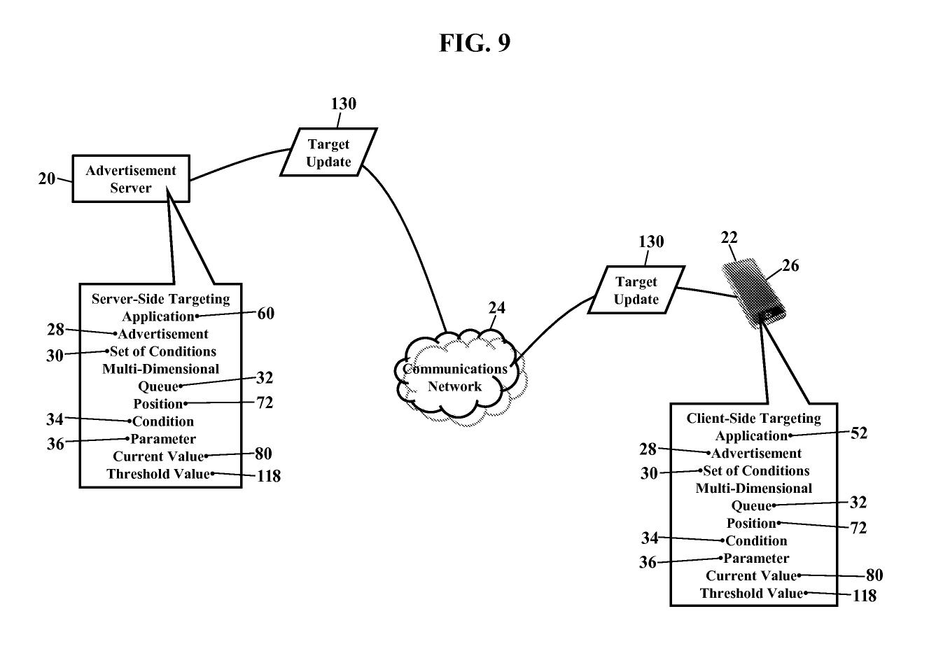

FIGS. 9-12 are schematics illustrating a target update 130, according to exemplary embodiments. Because the set 30 of conditions are locally evaluated by the end user device 22, advertisers are blind as to satisfaction of the set 30 of conditions. Even though the advertisement 28 has been downloaded to the end user device 22, the advertiser does not know when the advertisement 28 will be presented by the end user device 22. An advertiser, in other words, may want to know the position 72 of the advertisement 28 in the multi-dimensional queue 32.

FIG. 9 thus illustrates the target update 130. The target update 130 may include data or information that describes a current view or snapshot of the set 30 of conditions and/or the position 72 of the advertisement 28 in the multi-dimensional queue 32. The target update 130, for example, may include the current value 80 of each parameter 36 associated with the set 30 of conditions. The target update 130 may also include each threshold value 118 of the corresponding condition 34. After the client-side targeting application 52 generates the target update 130, the client-side targeting application 52 may instruct the processor (illustrated as reference numeral 50 in FIG. 3) to send the target update 130 to any network address for analysis. For simplicity, FIG. 9 illustrates the target update 130 routing back to the advertisement server 20. The target update 130, however, may be sent to any device or destination. The target update 130 may be periodically sent from the end user device 22, or the advertisement server 20 may send queries or polls for target updates from one or more end user devices. Regardless, the advertisement server 20 collects the target update 130 associated with the end user device 22. The target update 130, for example, may identify a device identifier, IP address, machine address, or any other unique identifier of the end user device 22. The target update 130 allows the server-side targeting application 60 to recreate the local targeting being conducted by the end user device 22.

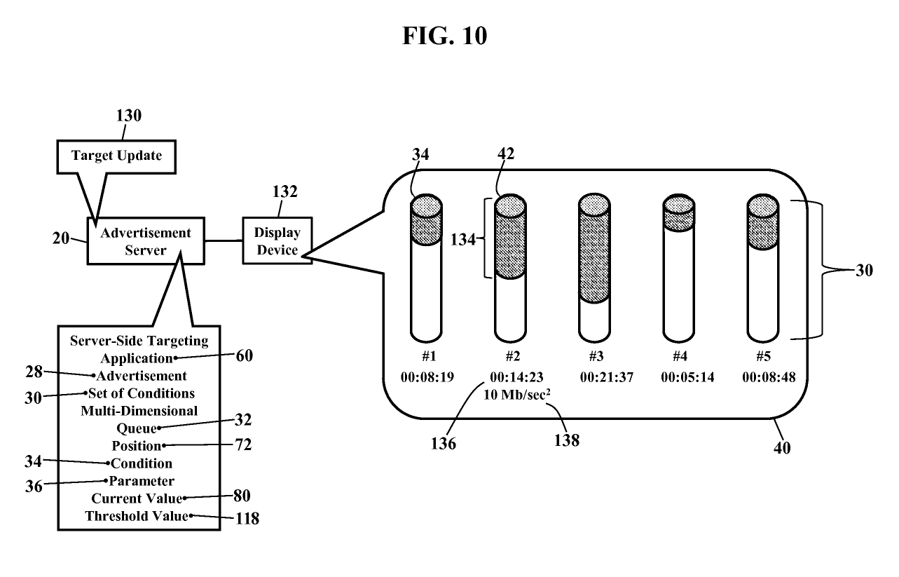

FIG. 10 illustrates a graphical view of the target update 130. Because the target update 130 is shared with the advertisement server 20, information in the target update 130 may be processed to remotely indicate or determine the position 72 of the advertisement 28 awaiting presentation in the multi-dimensional queue 32 of the end user device (illustrated as reference numeral 22 in FIG. 9). That is, even though the advertisement 28 is locally targeted by the end user device 22, exemplary embodiments may remotely inform the advertisement server 20 of progress towards satisfaction of the set 30 of conditions. Because the target update 130 may provide a current snapshot of the set 30 of conditions, the advertiser may determine the position 72 of the advertisement 28 in the local multi-dimensional queue 32.

The target update 130 may be visually produced. As FIG. 10 illustrates, the target update 130 may be processed for display on a display device 132. The target update 130 may be used to recreate the local targeting currently being conducted by the end user device (illustrated as reference numeral 22 in FIG. 9). The server-side targeting application 60, for example, visually represents each condition 34 in the set 30 of conditions as the chimney 42. The current value 80 of any parameter 36, associated with any individual condition 34, may also be recreated and visually represented. Because the target update 130 may also include the threshold value 118 associated with any condition 34, the server-side targeting application 60 may even determine and visually indicate a deficit 134 until the condition 34 is satisfied. That is, the server-side targeting application 60 may compare the current value 80 of the parameter 36 to the threshold value 118 associated with each condition 34 in the set 30 of conditions. The deficit 134 may thus represent some value remaining until the condition 34 is satisfied. The target update 130 may also be processed to recreate the position 72 of the advertisement 28 in the local multi-dimensional queue 32.

The deficit 134 may be expressed in time. When the current value 80 of the parameter 36 lags or is less than the threshold value 118, the corresponding condition 34 usually has yet to be satisfied. Exemplary embodiments may thus display the time that is required, or estimated, before the condition 34 is satisfied. So, once the deficit 134 is determined, exemplary embodiments may also estimate a time 136 to satisfaction of the condition 34. Because the end user device (illustrated as reference numeral 22 in FIG. 9) is locally processing the set 30 of conditions, the client-side targeting application 52 may determine a rate 138 toward satisfaction of any condition 34. The target update 130 may thus visually indicate the time 136 to satisfaction, and/or the rate 138 toward satisfaction, to help the advertiser anticipate presentation of the corresponding advertisement 28.

An example helps explain the time 136 to satisfaction. Suppose one of the conditions 34 in the set 30 of conditions requires some longitude and latitude coordinates (from a GPS system). Exemplary embodiments may obtain the current location of the end user device 22 and compare to the required longitude and latitude coordinates. As the current location changes, the client-side targeting application 52 may determine that the end user device 22 is moving at sixty (60) miles per hour with twenty five (25) miles remaining Given the rate 138 of change, the client-side targeting application 52 may determine that the GPS condition 34 will be satisfied in twenty five (25) minutes. So exemplary embodiments may determine that the time 136 to satisfaction is twenty five (25) minutes.

Another exemplary condition 34 may require a data consumption of 200 megabits per second. As the end user device (illustrated as reference numeral 22 in FIG. 9) consumes data, the client-side targeting application (illustrated as reference numeral 52 in FIG. 9) may monitor a network interface to determine the rate 138 of data consumption (such as bits received per second). As the client-side targeting application 52 counts or monitors an amount of bits received, exemplary embodiments may observe or determine that data reception is accelerating at the rate 138 of 10 megabits per second each second (e.g., 10 Mb/s²). The client-side targeting application 52 may thus project the time 136 to satisfaction is twenty (20) seconds before the end user device 22 consumes 200 megabits per second.

Whatever the deficit 134, exemplary embodiments may visually and simply summarize the time 136 to satisfaction for any condition 34. As the server-side targeting application 60 recreates the local targeting of the advertisement 28, the time 136 to satisfaction may be displayed for each respective condition 34. Indeed, as the set 30 of conditions may have several, or even many, separate conditions 34, there may be several or many different times 136 to satisfaction, with each time 136 to satisfaction calculated for a different one of the conditions 34. The server-side targeting application 60 may thus individually display each different time 136 to satisfaction.

While the different times 136 to satisfaction may be analytically interesting, most users may only want or need a single estimation. That is, even though there may be many conditions 34 associated with the advertisement 28, the viewer of the target update 130 may only care about when the advertisement 28 will be displayed. Most users, in other words, only need to know when the advertisement 28 is predicted to be displayed by the end user device 22.

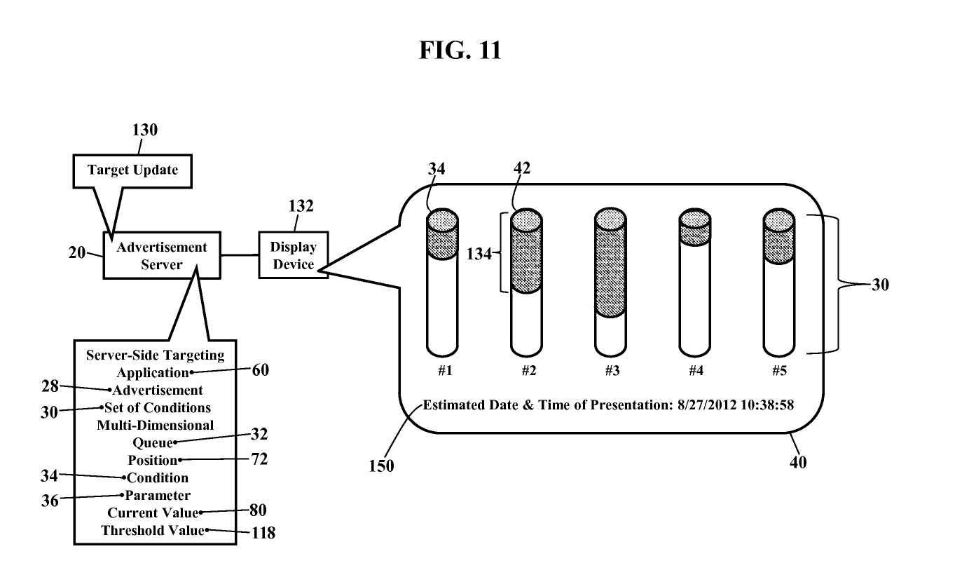

FIG. 11 thus illustrates an overall estimated date and time 150 of presentation. Exemplary embodiments may gather all the different times to satisfaction (illustrated as reference numeral 136 in FIG. 10) calculated for the different conditions 34 in the set 30 of conditions. Exemplary embodiments may then analyze the different times 136 to satisfaction to estimate a single time at which the entire set 30 of conditions is satisfied. Again, once the set 30 of conditions is entirely satisfied, then the advertisement 28 is released from the multi-dimensional queue 32 for display. Exemplary embodiments may thus determine the estimated date and time 150 of presentation, at which the advertisement 28 is displayed to the end user of the end user device 22. The estimated date and time 150 of presentation, for example, may be based on a maximum one of all the different times 136 to satisfaction. If one condition 34 in the set 30 of conditions requires several days until satisfaction, much shorter times 136 to satisfaction (associated with other conditions 34) may be so short as to be irrelevant. So exemplary embodiments may compare all the different times 136 to satisfaction associated with all of the conditions 34 in the set 30 of conditions and select a maximum value. The estimated date and time 150 of presentation may then be based on a summation of a current date and time and the maximum value, thus discarding all lesser/smaller times 136 to satisfaction. Exemplary embodiments may alternatively sum all the different times 136 to satisfaction associated with all of the conditions 34 in the set 30 of conditions and compute an average (based on N conditions in the set 30 of conditions). The estimated date and time 150 of presentation may then be based on a summation of the current date and time and the average.

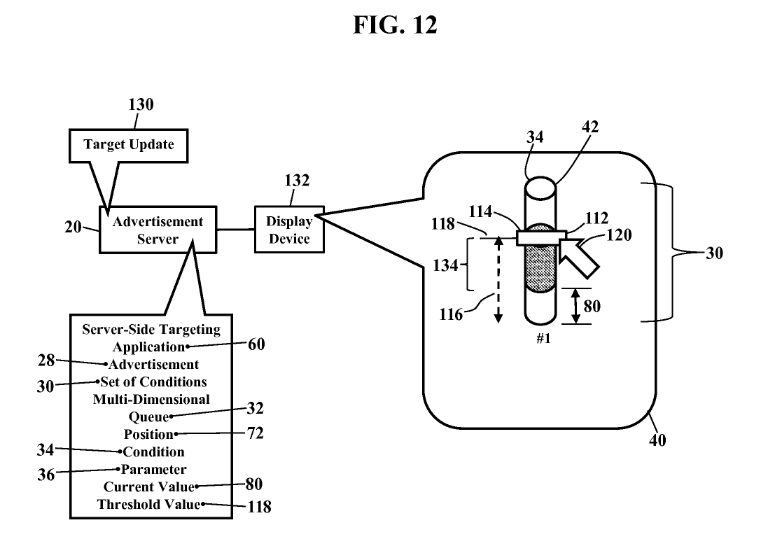

FIG. 12 illustrates recalibrating of local targeting, according to exemplary embodiments. Here the target update 130 allows an advertiser to quickly, and simply, change the set 30 of conditions associated with the advertisement 28 stored in any end user device (illustrated as reference numeral 22 in FIG. 10). Because the server-side targeting application 60 may graphically represent any condition 34 in the set 30 of conditions, the server-side targeting application 60 may also allow the advertiser to change the threshold value 118 associated with that same condition 34.

FIG. 12, for simplicity, again illustrates a single condition 34 in the set 30 of conditions. The condition 34 is again illustrated as the chimney 42. The current value 80 of the condition 34 may be preferably scaled in relation to the height or size of the corresponding chimney 42. The threshold value 118 associated with the condition 34 may be visually represented as the graphical control 112. The graphical control 112 is again illustrated as the slider 114, thus allowing the advertiser to simply change the threshold value 118. The advertiser places the cursor 120 on the graphical control 112. By moving the vertical location 116 of the slider 114, the advertiser may change the threshold value 118 of the corresponding condition 34. The advertiser may thus move the slider 114 to quickly change the corresponding threshold value 118. As the threshold value 118 is changed, the corresponding deficit 134 may increase or decrease. By moving the threshold value 118, the advertiser is able to change the set 30 of conditions associated with the advertisement 28.

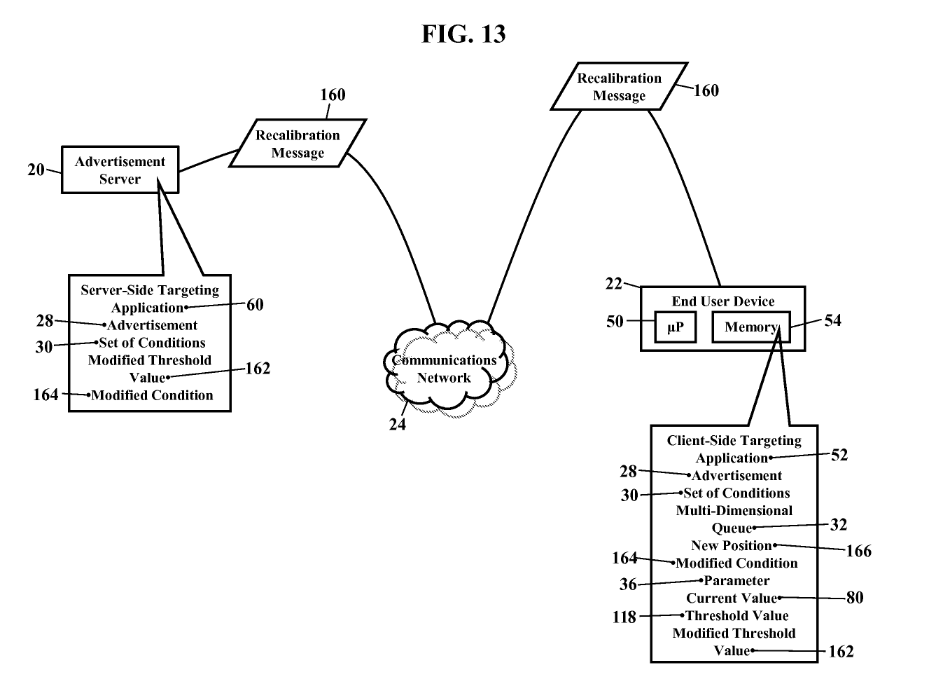

FIG. 13 is a schematic illustrating recalibration, according to exemplary embodiments. Even though the advertiser may remotely change the threshold values 118 associated with the set 30 of conditions, these changes must be communicated to the end user device 22. Because exemplary embodiments conduct local targeting by the end user device 22, the end user device 22 must be informed of the threshold values 118 recalibrated by the advertiser.

FIG. 13 thus illustrates a recalibration message 160. Once the advertiser completes a recalibration of the threshold values 118 (as explained with reference to FIGS. 9-12), the client-side targeting application 60 may cause the advertiser's server 132 to send the recalibration message 160 to the end user device 22. The recalibration message 160 routes along the communications network 24 to the network address associated with the end user device 22. The recalibration message 160 may contain information that describes the advertisement 28 and a modified threshold value 162 for the associated condition 34. Indeed, the recalibration message 160 may even describe a modified condition 164, thus allowing the advertiser to “tweak” any logic or rule governing presentation of the advertisement 28. When the end user device 22 receives the recalibration message 160, the client-side targeting application 52 suspends any current evaluation associated with the advertisement 28. The client-side targeting application 52 queries its memory 54 for the set 30 of conditions associated with the advertisement 28 under suspension. The client-side targeting application 52 retrieves the currently-stored threshold value 118 associated with the condition 34. The client-side targeting application 52 then replaces the stored threshold value 118 with the modified threshold value 162. The existing condition 34 may also be replaced by the modified condition 164. After the modified threshold value 162 is stored, the client-side targeting application 52 then resumes evaluation of the set 30 of conditions, but now using the modified threshold value 162 and/or the modified condition 164. Because the set 30 of conditions has now changed, the advertisement 28 may be promoted, or demoted, to a new position 166 within the multi-dimensional queue 32.

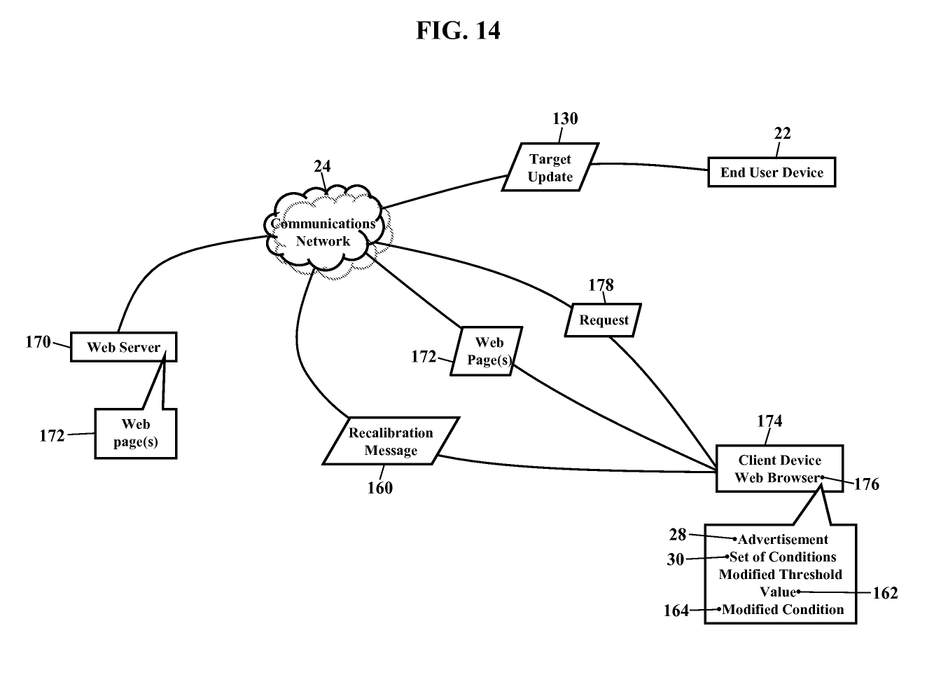

FIG. 14 is a schematic illustrating a web server 170, according to exemplary embodiments. Here the end user device 22 may send the target update 130 to the web server 170. When the web server 170 receives the target update 130, the web server 170 may generate one or more web pages 172 based on the target update 130. Any client device 174 may query the web server 170 for the web page(s) 172. That is, a web browser 176 stored in memory of the client device 174 causes a client processor to send a request 178 for the web page(s) 172. A processor in the web server 170 retrieves the corresponding web page(s) 172 from memory and returns the web page(s) 172 to the client device 174. The client device 174 may thus visually/audibly present the web page(s) 172, thus allowing a user of the client device 174 to view the set 30 of conditions associated with the advertisement 28. Should the user wish recalibration, the user generates the modified threshold value 162, and/or the modified 164. The client device 174 may then send the recalibration message 160. Exemplary embodiments thus include a web site, accessible from any web browser 176, that provides an update on the local targeting performed by the end user device 22.

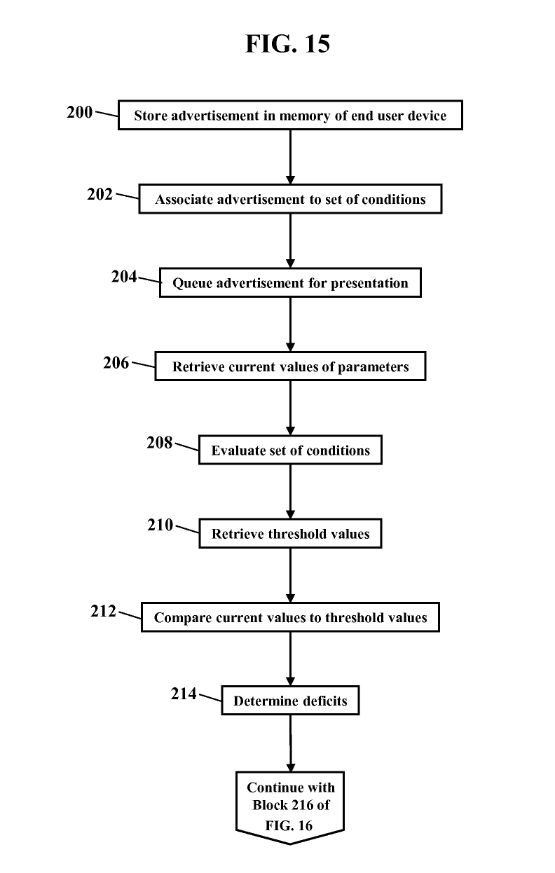

FIG. 15-18 are flowcharts illustrating a method or algorithm for targeting the advertisement 28, according to exemplary embodiments. The advertisement 28 is stored in memory of the end user device 22 (Block 200). The advertisement 28 is associated to the set 30 of conditions (Block 202). The advertisement 28 is queued for presentation in the multi-dimensional queue 32 (Block 204). The current values 80 of the parameters 36 are retrieved (Block 206). The set 30 of conditions is evaluated using the current values 80 of the parameters 36 (Block 208). The threshold values 118 are retrieved (Block 210) and compared to the current values 80 of the parameters 36 (Block 212). The deficits 134 are determined (Block 214).

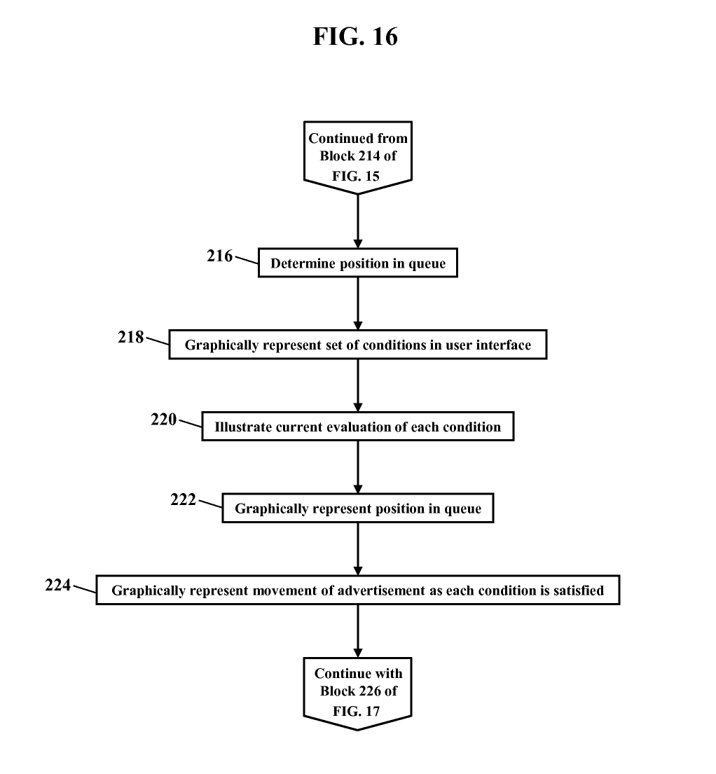

The algorithm continues with FIG. 16. The position 72 of the advertisement 28 in the multi-dimensional queue 32 is determined (Block 216). The set 30 of conditions is graphically represented in the user interface 40 (Block 218). The current evaluation of each condition 34 is illustrated (Block 220). The position 72 of the advertisement 28 in the multi-dimensional queue 32 is graphically represented (Block 222). The advertisement 28 is graphically moved in the user interface 40 as each condition 34 is satisfied (Block 224).

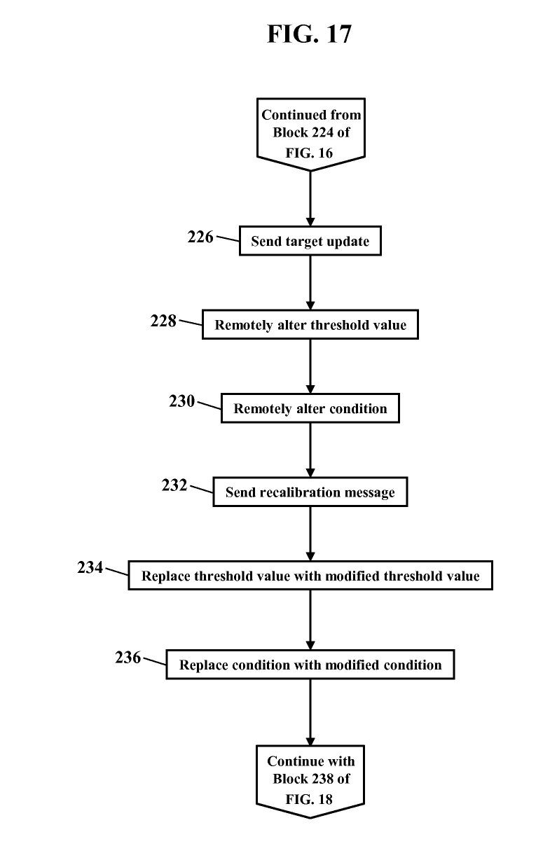

The algorithm continues with FIG. 17. The target update 130 is sent from the end user device 22 (Block 226). The threshold value 118 may be remotely altered (Block 228). Any condition 34 in the set 30 of conditions may also be remotely altered (Block 230). The recalibration message 160 is sent to modify local targeting (Block 232). The threshold value 118 is replaced with the modified threshold value 162 (Block 234). The condition 34 is replaced with the modified condition 164 (Block 236).

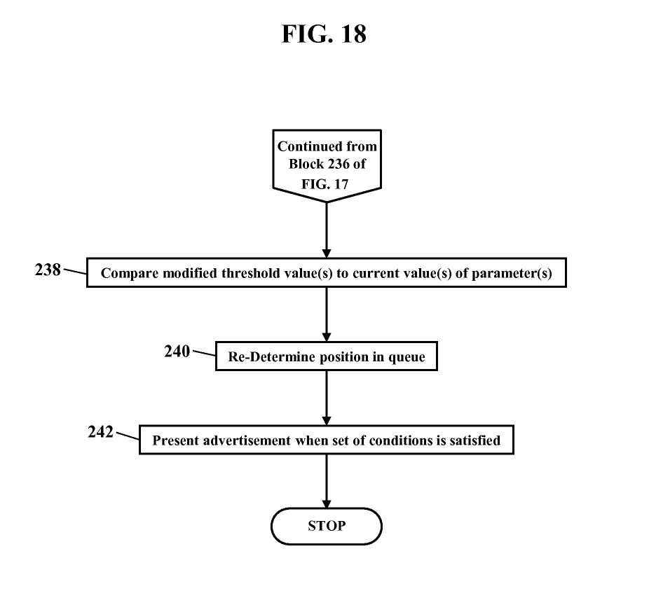

The algorithm continues with FIG. 18. The modified threshold value 162 is compared to the current values 80 of the parameters 36 (Block 238). The position 72 of the advertisement 28 in the multi-dimensional queue 32 is altered (Block 240). The advertisement 28 is presented when the set 30 of conditions is satisfied (Block 242).

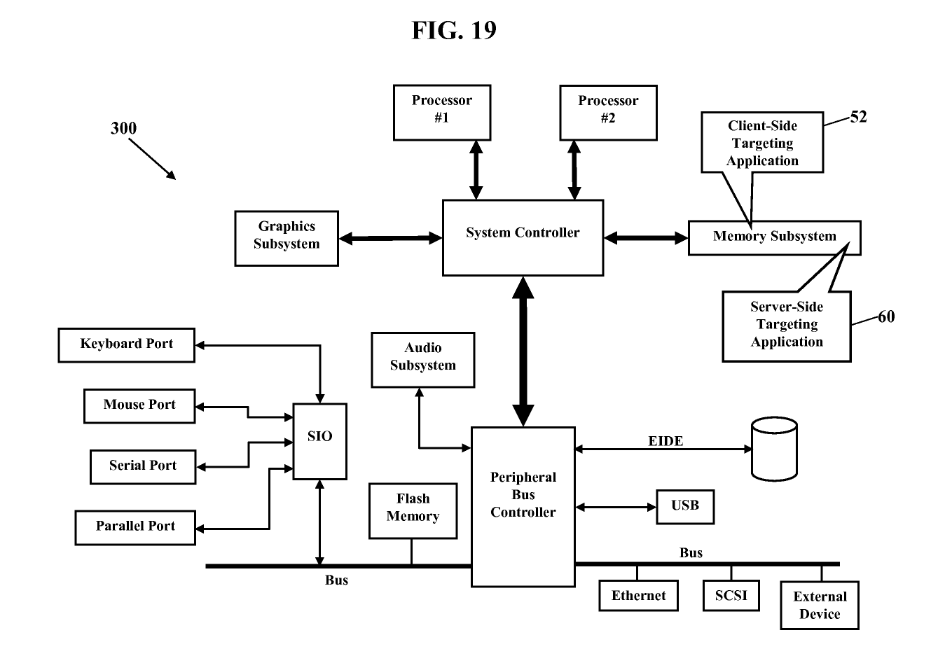

FIG. 19 is a schematic illustrating still more exemplary embodiments. FIG. 19 is a generic block diagram illustrating the client-side targeting application 52, and/or the server-side targeting application 60, operating within a processor-controlled device 200. As the previous paragraphs explained, the client-side targeting application 52 and/or the server-side targeting application 60 may operate in any processor-controlled device 300. FIG. 19, then, illustrates the client-side targeting application 52 and the server-side targeting application 60 stored in a memory subsystem of the processor-controlled device 300. One or more processors communicate with the memory subsystem and execute the client-side targeting application 52 and/or the server-side targeting application 60. Because the processor-controlled device 300 illustrated in FIG. 19 is well-known to those of ordinary skill in the art, no detailed explanation is needed.

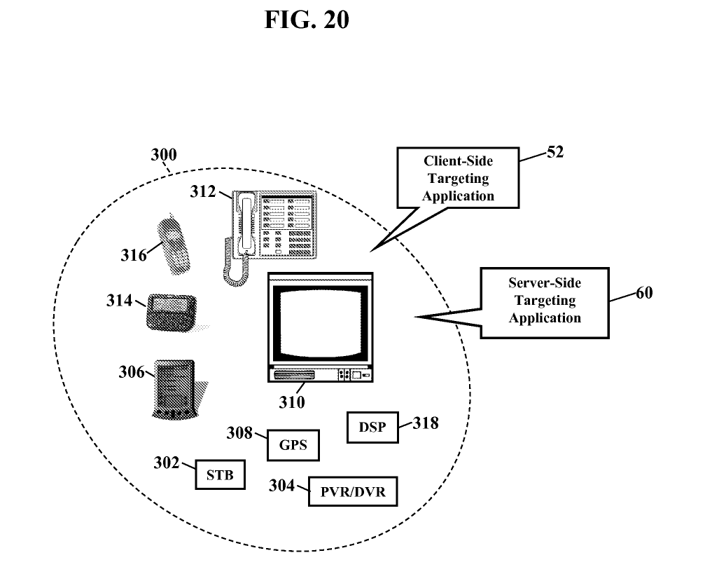

FIG. 20 depicts still more operating environments for additional aspects of the exemplary embodiments. FIG. 20 illustrates that the exemplary embodiments may alternatively or additionally operate within other processor-controlled devices 300. FIG. 20, for example, illustrates that the client-side targeting application 52 and/or the server-side targeting application 60 may entirely or partially operate within a set-top box (“STB”) (302), a personal/digital video recorder (PVR/DVR) 304, personal digital assistant (PDA) 306, a Global Positioning System (GPS) device 308, an interactive television 310, an Internet Protocol (IP) phone 312, a pager 314, a cellular/satellite phone 316, or any computer system, communications device, or any processor-controlled device utilizing a digital signal processor (DP/DSP) 318. The device 300 may also include watches, radios, vehicle electronics, clocks, printers, gateways, mobile/implantable medical devices, and other apparatuses and systems. Because the architecture and operating principles of the various devices 300 are well known, the hardware and software componentry of the various devices 300 are not further shown and described.

Exemplary embodiments may be physically embodied on or in a computer-readable storage medium. This computer-readable medium may include CD-ROM, DVD, tape, cassette, floppy disk, memory card, and large-capacity disks. This computer-readable medium, or media, could be distributed to end-subscribers, licensees, and assignees. A computer program product comprises processor-executable instructions for locally targeting advertisements, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A system, comprising:
a processor; and
memory to store instructions that, when executed by the processor, cause the processor to perform operations, the operations comprising:
queuing an advertisement in a queue in an end user device;
associating presentation of the advertisement to a set of conditions;
retrieving a parameter associated with the set of conditions;
comparing the parameter to the set of conditions;
determining by the end user device a position of the advertisement in the queue based on a comparison of the parameter to the set of conditions; and
presenting the advertisement at the end user device when the processor determines the set of conditions is satisfied.

2. The system according to claim 1, further comprising instructions that causes the processor to retrieve a threshold value associated with the set of conditions.

3. The system according to claim 2, further comprising instructions that causes the processor to compare the parameter to the threshold value.

4. The system according to claim 3, further comprising instructions that causes the processor to determine a deficit between the parameter to the threshold value.

5. The system according to claim 1, further comprising instructions that causes the processor to graphically represent the position of the advertisement in the queue.

6. The system according to claim 1, further comprising instructions that causes the processor to graphically indicate one of the conditions in the set of conditions.

7. A method, comprising:
queuing an advertisement for presentation in a queue stored in memory of an end user device;
associating the presentation to a set of conditions that must be satisfied;
retrieving parameters associated with the set of conditions;
comparing the parameters to the set of conditions;
determining by the end user device a position of the advertisement in the queue based on a comparison of the parameters to the set of conditions;
displaying a user interface;
prior to the presentation, graphically representing the comparison of the parameters to the set of conditions in the user interface;
determining the parameters satisfy the set of conditions; and
authorizing the presentation of the advertisement when the set of conditions is satisfied.

8. The method according to claim 7, further comprising retrieving a threshold value for one condition in the set of conditions.

9. The method according to claim 8, further comprising comparing at least one of the parameters to the threshold value.

10. The method according to claim 9, further comprising determining a deficit between the at least one parameter and the threshold value.

11. The method according to claim 8, further comprising graphically representing the threshold value as a graphical control in the user interface.

12. The method according to claim 11, further comprising graphically moving the graphical control to change the threshold value.

13. The method according to claim 12, further comprising changing the position of the advertisement in the queue based on a modified threshold value.

14. The method according to claim 7, further comprising graphically representing the position of the advertisement in the queue.

15. The method according to claim 7, further comprising graphically representing one of the conditions in the set of conditions as a chimney in the user interface.

16. The method according to claim 7, further comprising storing the user interface as a web page.

17. The method according to claim 16, further comprising receiving a request for the web page.

18. The method according to claim 16, further comprising retrieving the web page from memory.

19. A computer readable medium storing processor executable instructions for performing a method, the method comprising:
queuing an advertisement for presentation in a queue stored in memory of an end user device;
associating the presentation to a set of conditions that must be satisfied;
retrieving parameters associated with the set of conditions;
comparing the parameters to the set of conditions;
determining by the end user device a position of the advertisement in the queue based on a comparison of the parameters to the set of conditions;
displaying a user interface;
prior to the presentation, graphically representing the comparison of the parameters to the set of conditions in the user interface;
determining the parameters satisfy the set of conditions; and
authorizing the presentation of the advertisement when the set of conditions is satisfied.

20. The computer readable medium according to claim 17, further comprising instructions for receiving a recalibration message that changes the position of the advertisement in the queue.
